(19) United States
(12) Patent Application Publication
(10) Pub. No.: US 2002/0024648 A1
(43) Pub. Date: Feb. 28, 2002

(54) Exposure apparatus and exposure method

(76) Inventor: Yoshiyuki Tani, Osaka (JP)

Correspondence Address: NIXON PEABODY, LLP, 8180 GREENSBORO DRIVE, SUITE 800, MCLEAN, VA, 22102, US

(21) Appl. No.: 09/874,359

(22) Filed: Jun. 6, 2001

(30) Foreign Application Priority Data
Jun. 6, 2000 (JP) 2000-168479

(51) Int. Cl. G03B 27/72

(52) U.S. Cl. 355/69; 355/67; 355/30; 355/55; 355/53; 250/548; 356/400

(57) ABSTRACT

The first exposure stage is performed after the numerical aperture NA of a lens and a coherence factor σ have been set at 0.6 and 0.3 respectively, while respective mechanisms for adjusting an illuminating system, a lens system and a stage system have been fixed. Next, the numerical aperture NA of the lens and the coherence factor σ are changed into 0.5 and 0.8 respectively, without shifting the exposure position of a target to be exposed while the illuminating, lens and stage system are adjusted in such a manner that the aberration is minimized under these conditions. Then, the second exposure stage is performed after the mechanisms for adjusting the illuminating, lens and stage system have been fixed. An exposure process is carried out under several combinations of exposure conditions and the illuminating, lens and stage systems are adjusted in accordance with those combinations of exposure conditions. Thus, a high resolution and a great depth of focus are realized at a time with a sufficiently high throughput ensured.

### BACKGROUND OF THE INVENTION

The present invention relates to an exposure apparatus and method for use in an exposure process in fabricating a semiconductor device and more particularly relates to measures to define a highly accurate pattern while realizing wide applicability.

In general, resolution R and depth of focus DOF for a photolithography technique using a stepping projection aligner (stepper) are given by the following Rayleigh's equations (1) and (2)

R=k₁*λ/NA (1)

DOF=k₂*λ/NA² (2)

where λ is the wavelength of a light source, NA is the numerical aperture of an objective lens and k₁ and k₂ are coefficients, sometimes called “process coefficients”, which are empirically determined from coherence factor σ of an illuminating optical system, the resist material and the resist process used.

In this case, it is important to reduce (or improve) the resolution R to reduce the size of a pattern defined by a photolithographic process. To reduce the resolution R, a light source with a shorter wavelength λ may be used, the process coefficient k₁ may be reduced or the numerical aperture NA of a lens may be increased as can be seen from Equation (1). Therefore, in order to improve the resolution R when the wavelength λ of a light source is constant, it is necessary to increase the numerical aperture NA of the lens or reduce the coefficient k₁.

As can be seen from Equation (2), however, when the numerical aperture NA of the lens is increased, the depth of focus DOF decreases in proportion to NA², and accuracy will be lost for a very uneven pattern.

Meanwhile, the coherence factor σ is given by

σ=NA₁/NA_{R} (3)

where NA₁ is the numerical aperture of the illuminating system and NA_{R} is the numerical aperture of a lens system. It is known that when the coherence factor σ is reduced, the contrast and the depth of focus DOF will both increase. Therefore, the numerical aperture NA of the lens should be increased to improve the resolution R, while the coherence factor σ should be decreased to compensate for the decrease in depth of focus DOF.

If the coherence factor σ is decreased too much, the illuminance will decrease, thus possibly resulting in lower throughput (productivity) and narrow applicability to fabrication processes.

FIG. 7 is a table showing the results of photolithography processes that were performed using a conventional exposure apparatus. The data about the resolution R, the depth of focus DOF in a 0.22 μm line-and-space pattern, and the illuminance that were measured under the conditions A, B and C is shown in FIG. 7. In this case, the numerical aperture NA of the lens was set at 0.5 or 0.6 and the coherence factor σ was set at 0.8 or 0.3 using a stepper including a KrF eximer laser diode.

As shown in FIG. 7, according to the conditions A in which the numerical aperture NA of the lens was set at the greater one, the resultant resolution R improved but the depth of focus DOF decreased, compared to the conditions B in which the numerical aperture NA of the lens was set at the smaller one. On the other hand, according to the conditions C in which the conference factor σ was set at the smaller one, the resolution R improved compared to the conditions B, the depth of focus DOF increased compared to the conditions A, but the illuminance (mW/cm²) decreased compared to the conditions B, thus increasing the exposure time considerably.

### SUMMARY OF THE INVENTION

It is therefore an object of the present invention to provide an exposure apparatus and method for use in a photolithographic process to define a fine-line pattern ensuring sufficient applicability and by taking measures to improve the resolution while suppressing the decrease in depth of focus.

An exposure apparatus according to the present invention exposes a target, which is placed on a stage, to an exposing radiation that has been emitted from an illuminating system and then transmitted through a lens system. The apparatus is so constructed as to change a coherence factor of the illuminating system and a numerical aperture of the lens system and to control respective mechanisms for adjusting the illuminating and lens systems and a stage system in accordance with the coherence factor and the numerical aperture without shifting an exposure position of the target.

According to the present invention, it is possible to perform multiple exposure stages under mutually different combinations of conditions including the coherence factor of the illuminating system and the numerical aperture of the lens. Therefore, before the integrated exposure dose reaches a predetermined value required for a photolithographic process, an exposure stage can be carried out under such conditions as to result in a small resolution and a great depth of focus and another exposure stage can be carried out under such conditions as to result in a high illuminance. In this manner, a fine-line pattern can be defined with a sufficiently high throughput maintained.

In one embodiment of the invention, the mechanism for adjusting the illuminating system may include a mechanism for changing uniformity in illuminance.

In another embodiment of the invention, the mechanism for adjusting the lens system mechanism may include a mechanism for adjusting an internal pressure in the lens system. Then, it is possible to optimize the aberration of the lens system.

In still another embodiment, the mechanism for adjusting the lens system may include a mechanism for moving the position of at least one objective lens included in the lens system. Then, it is possible to correct an error of a focal point or aberration from their optimum values due to the change in coherence factor or numerical aperture.

In yet another embodiment, the mechanism for adjusting the stage system may include a mechanism for moving the stage, on which the target is placed, parallelly, vertically and/or obliquely to the optical axis of a lens included in the lens system. In this case, the stage is moved in at least two of the parallel, vertical and oblique directions. Then, it is possible to correct an error of a focal point due to the change in coherent factor or numerical aperture.

An inventive exposure method is for use to perform an exposure process until an integrated dose of an exposing radiation, to which a target placed on a stage is exposed, reaches a predetermined value. The method includes the step of a) performing a first exposure stage by exposing the target to the exposing radiation after a coherence factor of an illuminating system and a numerical aperture of a lens system have been fixed while respective mechanisms for adjusting the illuminating system, the lens system and a stage system have been controlled in accordance with the fixed coherence factor and the fixed numerical aperture. The method further includes the step of b) newly selecting a coherence factor for the illuminating system and/or a numerical aperture for the lens system while controlling the mechanisms for adjusting the illuminating, lens, and stage systems in accordance with the coherence factor and/or the numerical factor that has/have been newly selected. The method further includes the step of c) performing a second exposure stage while maintaining the coherence factor and the numerical aperture that have been used in the step b) and the mechanisms for adjusting the illuminating, lens and stage systems.

According to the inventive method, an exposure process is carried out under several combinations of exposure conditions to adjust the illuminating, lens and stage systems in accordance with those combinations of exposure conditions. Thus, it is possible to minimize the focus error resulting from a difference in aberration between any pair of conditions even when exposure stages are separately performed under multiple exposure conditions. As a result, a high resolution and a great depth of focus are realized at a time just as intended with a sufficiently high throughput ensured.

In one embodiment of the present invention, after the step c) has been performed, the steps b) and c) may be performed at least one more time. Then, multiple exposure stages can be performed under exposure conditions in a wider variety of combinations, thus resulting in remarkable effects.

### BRIEF DESCRIPTION OF THE DRAWINGS

FIG. 1 is a diagram schematically showing the arrangement of an exposure apparatus for use in embodiments of this invention.

FIG. 2 is a timing diagram showing numerical apertures of the lens, coherence factors, states of the adjusting mechanisms and exposure states during respective exposure stages according to a first embodiment of the present invention.

FIG. 3 is a table showing numerical apertures and coherence factors for the first and second exposure stages of the first embodiment.

FIG. 4 is a table showing the resolution and the depth of focus in a 0.22 μm line-and-space pattern obtained by the two exposure stages of the first embodiment.

FIG. 5 is a table showing numerical apertures and coherent factors for the first, second and third exposure stages of a second embodiment of the present invention.

FIG. 6 is a table showing the resolution and the depth of focus in a 22 μm line-and-space pattern obtained by the three exposure stages of the second embodiment.

FIG. 7 is a table showing the results of photolithographic processes that were performed using a conventional exposure apparatus.

### DESCRIPTION OF THE PREFERRED EMBODIMENTS

Embodiment 1

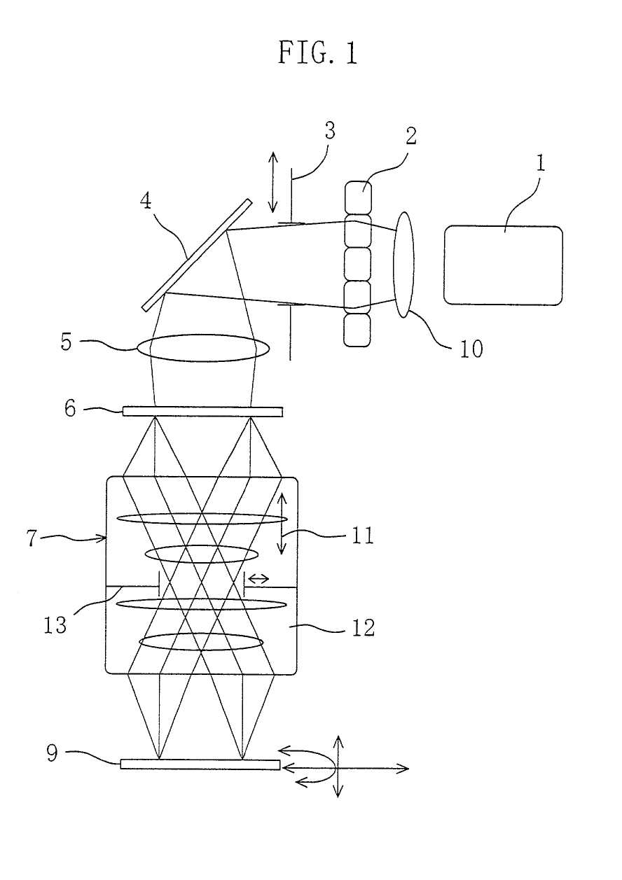

FIG. 1 is a diagram schematically showing the arrangement of an exposure apparatus for use in embodiments of this invention. In FIG. 1, the reference numeral 1 denotes a light source such as a KrF eximer laser diode. The reference numeral 2 denotes a lens for an illuminating system. The reference numeral 3 denotes a diaphragm for the illuminating system. The reference numeral 4 denotes a mirror. The reference numeral 5 denotes a condenser lens. The reference numeral 6 denotes a reticle. The reference numeral 7 denotes a projection lens system. The reference numeral 9 denotes a 6-axis stage on which a target to be exposed (e.g., wafer) is placed so as to move parallelly to x, y, z, θ, t₁ and t₂ directions and to have its stereoscopic angle changed. The reference numeral 10 denotes an illuminating system adjusting mechanism for changing the uniformity in illuminance using a method such as partial insertion of a filter. The projection lens system 7 includes, as its main parts: a lens position adjusting mechanism 11 to finely control the position of each lens in the system; an internal pressure adjusting mechanism 12; and a projection lens iris diaphragm 13 whose aperture area is variable. Although not shown in FIG. 1, an exposure dose integrating meter that is necessary to determine the end point of an exposure stage is also included in the system as in a general exposure apparatus.

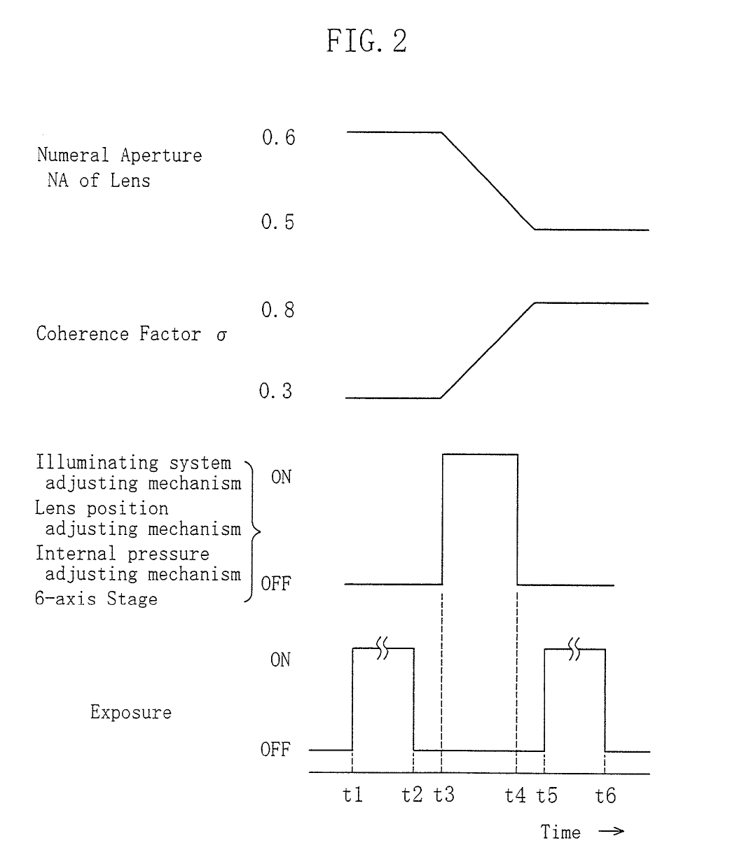

We conducted experiments of exposing a photoresist film using this exposure apparatus through a set of process steps in the following sequence. FIG. 2 is a timing diagram showing the numerical apertures NA of the lens, the coherence factors σ, the states of the adjusting mechanisms and the exposure states during the exposure process.

First, the project lens iris diaphragm 13 is controlled so that the numerical aperture NA of the lens will be 0.6 at the start of the first exposure stage, while the illuminating system diaphragm 3 is adjusted so that the coherence factor σ will be 0.3 at the start of the first exposure stage. At this time t1, the illuminating system adjusting mechanism 10, internal pressure adjusting mechanism 12, lens position adjusting mechanism 11 and 6-axis Stage 9 have already been adjusted so that the aberration is minimized under these conditions. That is to say, the mechanisms 9, 11 and 12 are OFF. Then, the first exposure stage is started at the time t1 and completed at a time t2 while the mechanisms 9, 11 and 12 are OFF.

Next, at a time t3, the projection lens iris diaphragm 13 is controlled so that the numerical aperture NA of the lens will be 0.5, while the illuminating system diaphragm 3 is adjusted so that the coherence factor σ will be 0.8. At the same time, the illuminating system adjusting mechanism 10, internal pressure adjusting mechanism 12, lens position adjusting mechanism 11 and 6-axis stage 9 are adjusted so that the aberration is minimized under these conditions. These mechanisms have to be adjusted before a time t4.

In this embodiment, a different sequence is adopted for the stepper compared to the conventional method. Specifically, only the 6 axes and the lens system are adjusted according to this embodiment to minimize the aberration. As for the conventional stepper, a step-and-repeat exposure process is performed. Thus, every time an exposure stage is finished, the exposure position is shifted before the next exposure stage is started. If the conventional procedure was applied to this embodiment, however, misalignment should occur between the exposure positions of the first and the second exposure stages. To cope with this, a program describing the sequence is modified according to this embodiment, thereby changing the numerical aperture NA of the lens and the coherence factor σ without shifting the exposure position.

Next, the second exposure stage is started at a time t5 and completed at a time t6 while the mechanisms 9, 11 and 12 are OFF. In this case, the times t1, t2, t5, and t6 are determined so that the sum of the integrated exposure doses of the first and the second exposure stages reaches a value predetermined by the resist material and the light source (wavelength characteristics) used in the system. In this procedure, each of the intervals between the times t1 and t2, t3 and t4, and t5 and t6 may be approximately 0.1 seconds.

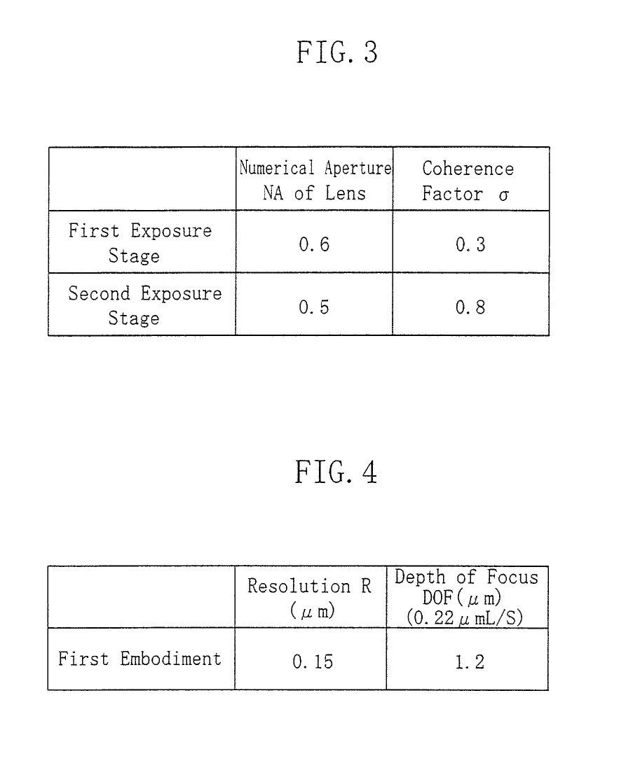

FIG. 3 is a table showing the numerical apertures NA of the lens and the coherence factors σ for the first and second exposure stages performed in accordance with the above sequence.

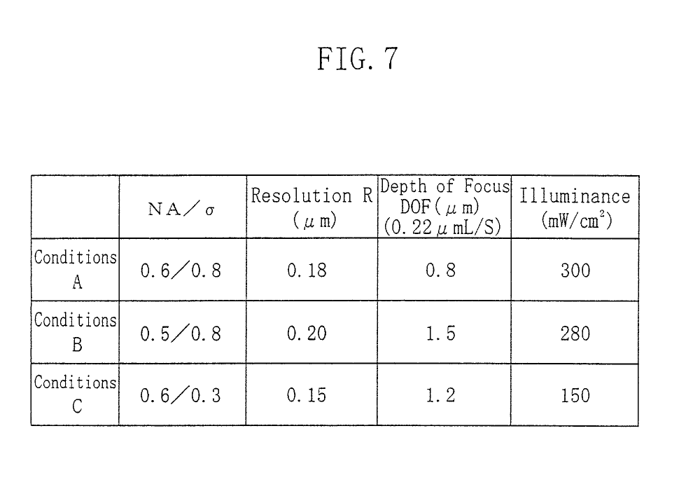

FIG. 4 is a table showing the resolution R and the depth of focus DOF in a 0.22 μm line-and-space pattern obtained by the two exposure stages following the sequence of this embodiment. As shown in FIG. 4, almost the same resolution R and depth of focus DOF were obtained as in the conditions C, including a relatively large numerical aperture NA of the lens of 0.6 and a relatively small coherent factor σ of 0.3 in the entire known exposure process shown in FIG. 7. In other words, in the method of this embodiment, the conditions of the first exposure stage are the same as the conventional conditions C. However, as for the second exposure stage, the numerical aperture NA of the lens is set smaller than, and the coherence factor σ is set larger than, the conventional conditions C. Therefore, the second exposure stage results in an illuminance of approximately 280 (mW/cm²), thus shortening the total exposure time.

In this embodiment, after the first exposure stage has been performed, the adjusting mechanisms are controlled in such a manner as to change the numerical aperture NA of the lens and the coherent factor σ before the second exposure stage is started. This realizes a smaller resolution R while suppressing the decrease in throughput or depth of focus DOF. As a result, an exposure apparatus or method, contributing to defining a fine-line pattern within the limits ensuring applicability, is provided.

Embodiment 2

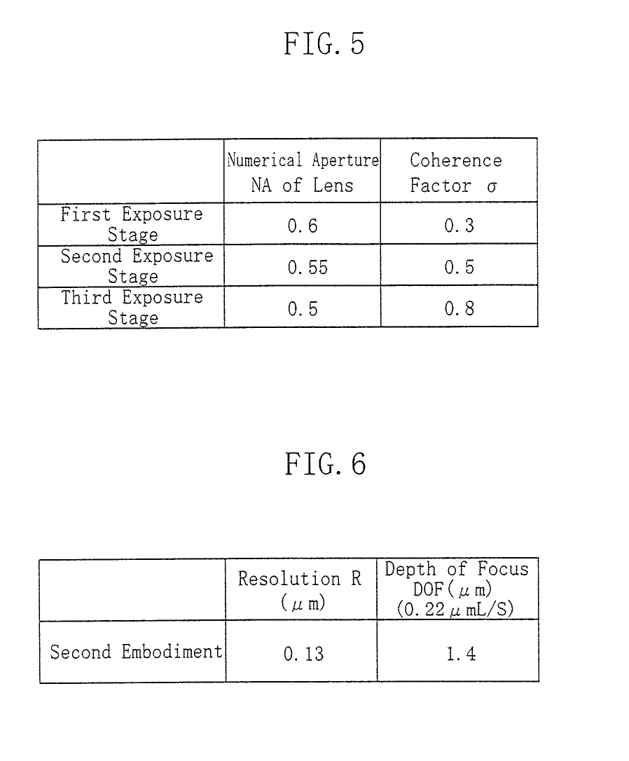

As for this embodiment, the apparatus shown in FIG. 1 is also used, and the description of the apparatus will be omitted herein. FIG. 5 is a table showing the numerical apertures NA and the coherent factors σ for the first, the second and the third exposure stages of this embodiment.

For this embodiment, the sequence for an exposure process will not be illustrated because the sequence should be easily understood by reference to the description of the first embodiment. First, the projection lens iris diaphragm 13 is controlled so that the numerical aperture NA of the lens will be 0.6 at the start of the first exposure stage while the illuminating system diaphragm 3 is adjusted so that the coherence factor σ will be 0.3 at the start of the first exposure stage. Then, the first exposure is performed after the illuminating system adjusting mechanism 10, internal pressure adjusting mechanism 12, lens position adjusting mechanism 11 and 6-axis Stage 9 have been adjusted for minimizing the illuminance and turned OFF. After the first exposure stage is finished, the mechanisms 9, 10, 11 and 12 for changing the numerical aperture NA of the lens and the coherent factor σ will be operated first; the second exposure stage will be carried out next; the mechanisms 9, 10, 11 and 12 will be operated again for the purpose of changing the numerical aperture NA of the lens and the coherence factor σ; and then the third exposure stage will be performed in order.

FIG. 6 is a table showing the resolution R and the depth of focus DOF in a 22 μm line-and-space pattern obtained by the three exposure stages following the sequence of this embodiment. As shown in FIG. 6, it can be seen that the resolution R and the depth of focus DOF have both further improved compared to the first embodiment.

In the first embodiment, a stepper including a KrF eximer laser diode that outputs a laser beam at a wavelength of 248 nm is used as the light source 1, but this invention is not limited to such a specific embodiment.

In the foregoing embodiments, the numerical aperture NA of the lens is set within the range from 0.5 through 0.6 and the coherence factor σ is set within the range from 0.3 through 0.8. However, according to the present invention, the numerical aperture NA of a lens and the coherent factor σ are not limited to these ranges.

Furthermore, the illuminating, lens and stage systems are controllable by the internal pressure adjustment, three-dimensional adjustment of the stage surface, and adjustment in uniformity of the illuminance as described for the foregoing embodiments. However, it is not always necessary to change all of these factors. It depends on the coherence factor of the illuminating system and a variation in the numerical aperture of the lens which factor should be changed. That is to say, sometimes these factors must be all corrected and sometimes none of these factors has to be corrected.

It is also possible to adopt other correction methods, instead of those described for the foregoing embodiments, as specific methods for making correction on the illuminating, lens and stage systems of those embodiments. Examples of the correction methods include insertion of an optical filter, use of an iris filter, and change of the wavelength of the light source. These methods may be used in an arbitrary combination, but applicable correction methods are not limited to these.

What is claimed is:

1. An exposure apparatus for exposing a target, which is placed on a stage, to an exposing radiation that has been emitted from an illuminating system and then transmitted through a lens system,
wherein the apparatus is so constructed as to change a coherence factor of the illuminating system and a numerical aperture of the lens system and to control respective mechanisms for adjusting the illuminating and lens systems and a stage system in accordance with the coherence factor and the numerical aperture without shifting an exposure position of the target.

2. The apparatus of claim 1, wherein the mechanism for adjusting the illuminating system comprises a mechanism for changing uniformity in illuminance.

3. The apparatus of claim 1, wherein the mechanism for adjusting the lens system comprises a mechanism for adjusting an internal pressure in the lens system.

4. The apparatus of claim 1, wherein the mechanism for adjusting the lens system comprises a mechanism for moving the position of at least one objective lens included in the lens system.

5. The apparatus of claim 1, wherein the mechanism for adjusting the stage system comprises a mechanism for moving the stage, on which the target is placed, parallelly, vertically and/or obliquely to the optical axis of a lens included in the lens system, the stage being moved in at least two of the parallel, vertical and oblique directions.

6. A method for performing an exposure process until an integrated dose of an exposing radiation, to which a target placed on a stage is exposed, reaches a predetermined value, the method comprising the steps of:
a) performing a first exposure stage by exposing the target to the exposing radiation after a coherence factor of an illuminating system and a numerical aperture of a lens system have been fixed while respective mechanisms for adjusting the illuminating system, the lens system and a stage system have been controlled in accordance with the fixed coherence factor and the fixed numerical aperture;
b) newly selecting a coherence factor for the illuminating system and/or a numerical aperture for the lens system while controlling the mechanisms for adjusting the illuminating, lens, and stage systems in accordance with the coherence factor and/or the numerical factor that has/have been newly selected; and
c) performing a second exposure stage while maintaining the coherence factor and the numerical aperture that have been used in the step b) and the mechanisms for adjusting the illuminating, lens and stage systems.

7. The method of claim 6, wherein after the step c) has been performed, the steps b) and c) are performed at least one more time.
